(19) United States
(12) Patent Application Publication
(10) Pub. No.: US 2026/0351809 A1
(43) Pub. Date: Nov. 5, 2026

(54) ANODE FOR SECONDARY BATTERY, MANUFACTURING METHOD THEREOF AND LITHIUM SECONDARY BATTERY INCLUDING THE SAME

(71) Applicant: SK ON CO., LTD., Seoul (KR)

(72) Inventors: Kyung Hee JEONG, Daejeon (KR); Sung Wan PARK, Daejeon (KR)

(21) Appl. No.: 19/676,533

(22) Filed: May 13, 2026

Related U.S. Application Data
(63) Continuation-in-part of application No. 18/448,691, filed on Aug. 11, 2023, now Pat. No. 12,633,512.

(30) Foreign Application Priority Data
Nov. 17, 2022 (KR) 10-2022-0154449

(51) Int. Cl. H01M 50/533; H01M 4/02; H01M 4/36; H01M 4/38; H01M 4/587; H01M 4/70; H01M 10/052

(52) U.S. Cl. CPC H01M 50/533; H01M 4/364; H01M 4/386; H01M 4/587; H01M 4/70; H01M 10/052; H01M 2004/021

(57) ABSTRACT

According to an embodiment, an electrode for a secondary battery includes: a current collector including a body portion and an electrode tab portion extending from the body portion; and an electrode mixture layer located on the body portion, wherein, with a direction in which the electrode tab portion extends defined as a first direction, the current collector includes a first straight edge portion in a second direction, perpendicular to a first direction on one side of the current collector on which the electrode tab portion is located, and the first straight edge portion and a second straight edge portion in the first direction of the electrode tab portion are connected by a rounded portion which is a curved edge portion, and a ratio R/D of a curvature radius R of the rounded portion to a thickness D of the current collector satisfies 250.0 to 333.3.

### CROSS-REFERENCE TO RELATED APPLICATION

This application is a continuation-in-part of U.S. patent application Ser. No. 18/448,691, filed on Aug. 11, 2023. This application also claims the priority and benefit of Korean Patent Application No. 10-2022-0154449 filed on Nov. 17, 2022. The entire disclosures of the above applications are incorporated herein by reference.

### TECHNICAL FIELD

The disclosed technology relates to an electrode for devices with electrodes including, e.g., electrochemical devices such as a secondary battery and method of designing an electrode.

### BACKGROUND

With recent interest in environmental issues, demand for secondary batteries, which can be used as power sources for electric vehicles (EVs) and portable electronic devices, is increasing. Typically, a secondary battery includes an anode, a cathode, and a separator interposed therebetween, and the anode includes a carbon-based active material, such as graphite, as an active material.

### SUMMARY

The disclosed technology can be implemented in some embodiments to provide an electrode for a device having electrodes including, e.g., an electrochemical device such as a secondary battery, which has excellent life characteristics by significantly reducing or eliminating fracturing of a current collector, while maintaining a thin thickness of the current collector.

The disclosed technology can also be implemented in some embodiments to provide a method of designing an electrode for various devices including a secondary battery capable of effectively suppressing fracture, while maintaining a thin thickness of a current collector.

According to an embodiment of the present invention, an electrode for a secondary battery includes a current collector including a body portion and an electrode tab portion extending from the body portion; and an electrode mixture layer disposed on the body portion, wherein, with a direction in which the electrode tab portion extends defined as a first direction, the current collector includes, on one side of the current collector on which the electrode tab portion is located, a first straight edge portion in a second direction, perpendicular to a first direction, and the first straight edge portion and a second straight edge portion in the first direction of the electrode tab portion are connected by a rounded portion, which is a curved edge portion, wherein a ratio R/D of a curvature radius R of the rounded portion to a thickness D of the current collector is 250.0 to 333.3.

In an embodiment, the rounded portion may be included in a circumference of the body portion on the current collector.

In an embodiment, the rounded portion may be included in a circumference of a bare portion including the electrode tab portion on the current collector.

In an embodiment, the thickness D of the current collector may be in a range of 1.0 to 10.0 μm.

In an embodiment, the rounded portion may be located at both ends of the body portion side of the electrode tab portion.

In an embodiment, the electrode may be a positive electrode or a negative electrode.

In an embodiment, the electrode mixture layer may include a silicon-based active material.

In an embodiment, the silicon-based active material may include at least one of Si, SiOₓ (0<x<2), Q-doped or Q-coated SiOₓ (0<x<2), Si-Q alloy, or Si—C composite, wherein Q may be an element selected from the group consisting of alkali metals, alkaline earth metals, Group 13 elements, Group 14 elements, Group 15 elements, Group 16 elements, transition metals, rare earth elements, or a combination of one or more of alkali metals, alkaline earth metals, Group 13 elements, Group 14 elements, Group 15 elements, Group 16 elements, transition metals, and rare earth elements, other than Si.

In an embodiment, the electrode mixture layer may contain a carbon-based active material.

In an embodiment, the carbon-based active material may include soft carbon, hard carbon, natural graphite, artificial graphite, carbon nanotubes, graphene, carbon fiber, graphitized mesocarbon microbeads, or a mixture thereof.

In an embodiment, the content of silicon-based active material in the electrode mixture layer may be 3 to 50 wt %.

In an embodiment, the electrode mixture layer may further include a conductive material, a binder, or both of the conductive material and a binder.

The lithium secondary battery according to one embodiment includes the electrode for a secondary battery.

According to an embodiment, a method of designing an electrode for a secondary battery includes the operations of: in a current collector including a body portion on which an electrode mixture layer is located and an electrode tab portion extending from the body portion, setting, with a direction in which the electrode tab portion extends defined as a first direction, a region including an intersection point where a third straight edge portion in a second direction perpendicular to the first direction on one side of the current collector on which the electrode tab portion is located and a fourth straight edge portion in the first direction of the electrode tab portion intersect with each other as a rounded portion region connecting the third straight edge portion and the fourth straight edge portion; and setting a curvature radius of the rounded portion based on a thickness of the current collector.

In an embodiment, the curvature R of the rounded portion may be set such that a ratio R/D of the curvature radius R to the thickness D of the current collector satisfies 250.0 to 333.3.

### BRIEF DESCRIPTION OF DRAWINGS

Certain features and advantages of the disclosed technology are illustrated by the following detailed description with reference to the accompanying drawings.

FIG. 1 is a cross-sectional view illustrating an example of an electrode for devices with electrodes such as secondary batteries based on some embodiments of the disclosed technology.

FIGS. 2 to 4 are top views illustrating examples of an electrode for devices with electrodes such as secondary batteries based on some embodiments of the disclosed technology.

FIG. 5 is a schematic diagram illustrating design operations based on some embodiments of the disclosed technology.

FIG. 6 is a top view illustrating an example of an electrode for devices with electrodes such as secondary batteries based on some embodiments of the disclosed technology.

### DETAILED DESCRIPTION

Section headings are used in the present document only for ease of understanding and do not limit scope of the embodiments to the section in which they are described.

Features of the technology disclosed in this patent document are described by example embodiments with reference to the accompanying drawings.

### Electrode for Secondary Battery

The insertion and deinsertion of ions (e.g., lithium ions) in the electrodes (positive electrode or negative electrode) of a secondary battery cause volume changes of the electrodes. Since the volume change of the electrode is a three-dimensional change, volume change occurs not only in a thickness direction (Z-axis) in which the positive electrode, the separator, and the negative electrode are stacked, but also in surface directions (X-axis and Y-axis) of the electrode. The volume change in the surface directions of the electrode may concentrate stress on the electrode tab portion protruding from the electrode in the surface direction, thereby causing deformation and breakage of the electrode (current collector). Specifically, in the bare portion including the electrode tab portion and being a portion on the surface of the current collector on which no electrode mixture layer is formed, more specifically, at a boundary between a portion on which the electrode mixture layer is formed and a portion on which the electrode mixture layer is not formed when the electrode active material expands, strong stress concentration may occur, and thus a phenomenon in which the current collector is fractured may occur. The breakage risk of the current collector due to such stress concentration may be increased as the volume change of the electrode active material caused by the insertion and deinsertion of lithium ions becomes larger.

As described above, the inventors have confirmed that when the current collector has a structure in which the body portion and the electrode tab portion are integrated with each other, the portion where stress in an electrode surface direction is most concentrated due to volume change occurring in the electrode mixture layer is an end edge of the body portion side of the electrode tab portion, and breakage of the electrode starts from the end edge of the body portion side of the electrode tab portion. In addition, it was also confirmed that when the thickness of the current collector is reduced for lightening and miniaturization of the secondary battery, increasing energy density of the secondary battery, and/or reducing production costs of the secondary battery, the electrode is more easily broken by stress in the electrode surface direction. Based on this confirmation, there are provided an electrode for a secondary battery and a method of designing the electrode in which concentration of stress generated in a surface direction of the electrode (hereinafter, collectively referred to as ‘surface direction stress’) is suppressed (relieved), so that breakage of the electrode may be prevented even when based on a thin current collector.

According to an embodiment, an electrode for secondary batteries includes a current collector including a body portion and an electrode tab portion extending from the body portion; and an electrode mixture layer located on the body portion, wherein, with a direction in which the electrode tab portion extends defined as a first direction, the current collector includes a first straight edge portion in a second direction, perpendicular to a first direction on one side of the current collector on which the electrode tab portion is located, and the first straight edge portion and a second straight edge portion in the first direction of the electrode tab portion are connected by a rounded portion, which is a curved edge portion, and a ratio R/D of a curvature radius R of the rounded portion to a thickness D of the current collector is 250.0 to 333.3. When R/D is less than 250.0 or when R/D exceeds 333.3, the rounded portion may be vulnerable to surface direction stress generated as charging and discharging of the secondary battery including the electrode are repeated, or stress dispersion by the rounded portion may be insignificant, and thus breakage may occur (start) at an end edge of the electrode tab portion on the body portion side. As described above, since the first straight edge portion and the second straight edge portion are connected by the rounded portion, and the ratio R/D of the curvature radius R of the rounded portion to the thickness D of the current collector satisfies 250.0 to 333.3, electrode deformation due to swelling and fracture of the current collector may be suppressed without increasing the thickness of the electrode current collector.

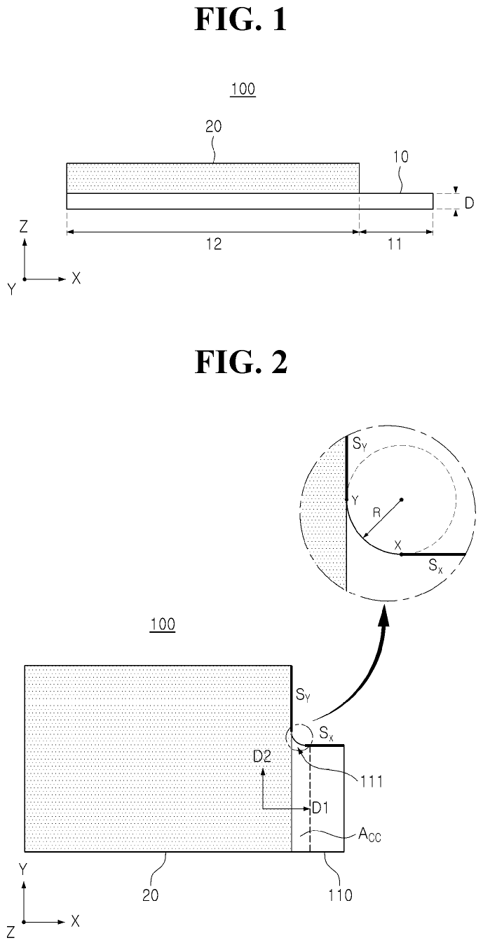

FIG. 1 shows an example of an implementation of an electrode 100 of the disclosed technology. This electrode and other electrodes disclosed in this patent document can be used as an anode (a negative electrode) or a cathode (a positive electrode) in various devices including electrochemical devices such as batteries. An electrode 100 for secondary battery includes a current collector 10 and an electrode mixture layer 20 disposed on at least one surface of the current collector, wherein the electrode mixture layer 20 includes an active material, wherein the current collector includes a body portion and an electrode tab portion extending form the body portion. The body portion 12 may be a region of the current collector on which the electrode active material layer is disposed. A region of the current collector on which the electrode mixture layer is not disposed may be collectively referred to as an bare portion 11, and the electrode tab portion may also belong to the bare portion 11. The body portion 12 and the electrode tab portion may form a one-piece structure, wherein the electrode tab portion may be a portion of the current collector configured to be electrically connected to an external terminal of the secondary battery.

FIG. 2 is a top view schematically illustrating the secondary battery electrode according to an embodiment. As shown in FIG. 2, the first direction D1 in the current collector may be a direction in which the electrode tab portion 110 extends from the body portion, and the second direction D2 may be a direction which is perpendicular to the first direction. Including FIG. 2, the examples illustrated in the drawings are examples in which the X-axis direction and the D1 direction are parallel to each other and the Y-axis direction and the D2 direction are parallel to each other in the X-Y-Z Cartesian coordinate system (an external coordinate system outside the electrode). The current collector may include a first straight edge portion S_{Y}, in the second direction D2 on one side of the current collector where the electrode tab portion 110 is located, and a second straight edge portion S_{X}, in the first direction D1 at the electrode tab portion 110. When there are two or more first straight edge portions and two or more second straight edge portions in the current collector, the first straight edge portion and second straight edge portion that are adjacent (closest) to each other may be connected by a rounded portion. At this time, the center of curvature of the rounded portion (curved edge portion) may be located outside the electrode (or current collector), and the curved edge portion may have a concave shape.

As described above, the periphery of the current collector may include a first straight edge portion S_{Y} located at the side where the electrode tab portion 110 extends and a second straight edge portion S_{X} located at the electrode tab portion, and the first straight edge portion S_{Y} and the second straight edge portion S_{X} may be connected by the rounded portion 111 which is a curved edge portion. Specifically, there may be a first point X that is a point where the periphery of the current collector changes from a linear shape to a curved shape between the first straight edge portion S_{Y} and the rounded portion 111, and there may be a second point Y that is a point where the periphery of the current collector changes from a linear shape to a curved shape between the second straight edge portion S_{X} and the rounded portion 111. The rounded portion 111 may be connected to the first straight edge portion S_{Y} and the second straight edge portion S_{X} through the first point X and the second point Y, and have a concave curvature.

The thickness D of the current collector may be in a range of 1.0 to 10.0 μm. Specifically, the current collector may be an ultra-thin current collector having a thickness D less than 8.0 μm. The thickness D of the ultra-thin current collector may be 1.0 μm or more and less than 8.0 μm, specifically, 1.0 to 7.5 μm, 1.0 to 7.0 μm, 1.0 to 6.5 μm, 1.0 to 6.0 μm, 3.0 to 7.0 μm, 3.0 to 6.5 μm, or 3.0 to 6.0 μm. An ultra-thin current collector having the aforementioned thickness enables secondary batteries to be lightened and miniaturized, increases energy density of the secondary battery, and reduces production cost. According to some embodiments, although the electrode includes an ultra-thin current collector having a thickness of less than 8 μm, since the ratio R/D of the curvature radius R of the rounded portion to the thickness D of the current collector satisfies 250.0 to 333.3, damage to the electrode due to surface direction stress may be prevented even when the electrode mixture layer contains an electrode active material, such as a silicon-based active material, that causes very large surface direction stress.

As shown in FIG. 2, the rounded portion 111 may be included in a circumference of the bare portion on the current collector. That is, the current collector region A_{CC} having the curved edge portion of the rounded portion 111 and extending in the second direction from the curved edge portion may belong to the bare portion, and the electrode mixture layer 20 may not be located on the current collector region A_{CC}.

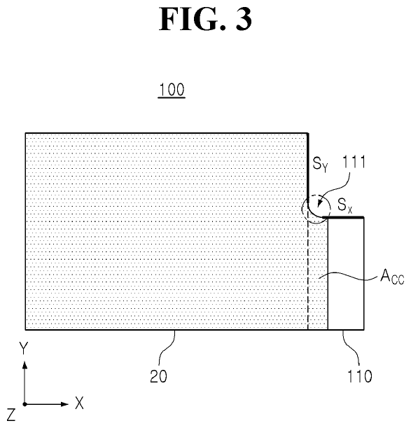

FIG. 3 is a conceptual top view of the electrode for secondary battery according to one embodiment. As shown in FIG. 3, the rounded portion 111 may be included in the circumference of the body portion. That is, the current collector region A_{CC} having the curved edge portion of the rounded portion 111 and extending in the second direction from the curved edge portion may belong to the body portion, and the electrode mixture layer 20 may be located on the current collector region A_{CC}.

Although not shown in the drawings, a portion of the rounded portion 111 may also belong to the circumference of the body portion and another portion of the rounded portion 111 may belong to the circumference of the bare portion. However, in this case, uneven stress relief may occur at the rounded portion 111, and when the electrode mixture layer contains an electrode active material having a large volume change such as silicon-based active material, the rounded portion 111 may belong to a circumference of the body portion of the current collector or to a circumference of the bare portion of the current collector so that stress relief by the rounded portion 111 may be more stably implemented.

In an embodiment, the first straight edge portion S_{Y} may belong to a perimeter of the body portion (see FIG. 2 or 3) or a perimeter of the bare portion. When the first straight edge portion S_{Y} belongs to the circumference of the bare portion, a distance in the first direction between the first straight edge portion S_{Y} and the edge of the electrode mixture layer may be about 0.1 mm to 2.5 mm, but is not limited thereto.

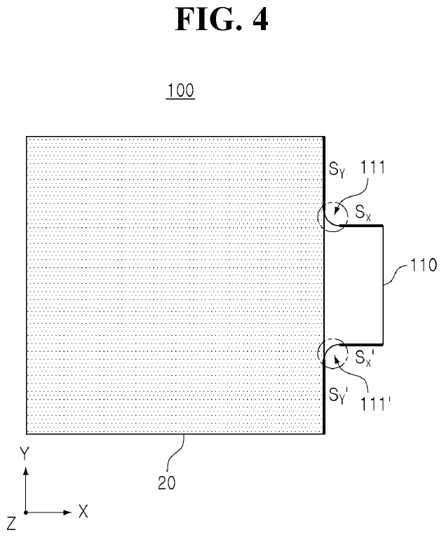

FIG. 4 is a conceptual top view of the electrode for secondary battery according to one embodiment. As shown in an example of FIG. 4, the rounded portions 111 and 111′ may be located at both ends of a body portion side of an electrode tab portion 110. At this time, both ends of the body portion side may be the both ends in the second direction D2. Specifically, the current collector may have at least two first straight edge portions S_{Y} and S_{Y}′ on one side of the current collector where the electrode tab portion 110 is disposed, and at least two second straight edge portions S_{X} and S_{X}′ on the electrode tab portion. At this time, the adjacent first straight edge portion S_{Y} and the second straight edge portion may be connected by the rounded portion 111, and the adjacent first straight edge portion S_{Y}′ and the second straight edge portion S_{X}′ may be connected by the rounded portion 111′. When the rounded portions 111 and 111′, which are located at both ends of the body portion side of the electrode tab portion 110, are collectively referred to as a first rounded portion 111 and a second rounded portion 111′, the first rounded portion 111 and the second rounded portion 111′ may satisfy R/D of 250.0 to 333.3. At this time, as long as R/D satisfies 250.0 to 333.3, the curvature radius of the first rounded portion 111 and the second rounded portion 111′ may be the same or different from each other.

As described above, the electrode according to an embodiment may disperse and relieve a surface-direction stress concentrated at both ends of the body portion side end of the electrode tab portion, thereby improving durability and lifetime of the electrode. Accordingly, when it is desired to prevent physical damage of the electrode due to volume change during charging/discharging, the electrode according to an embodiment may be adopted.

In some embodiments, the electrode for a secondary battery may be a cathode (positive electrode). When the electrode is a positive electrode, the electrode mixture layer may be a positive electrode mixture layer and the positive electrode mixture layer may contain a positive electrode active material as an electrode active material.

The positive electrode active material may be a material capable of reversibly intercalating and deintercalating lithium ions. Representative examples of the positive electrode active material may include a layered lithium metal oxide, a spinel lithium metal oxide, a lithium phosphate-based compound or a mixture thereof.

The layered lithium metal oxide may include LiMO₂ (M is one or more selected from transition metals including Co and Ni), which is substituted with one or more hetero elements selected from Mg, Al, Fe, Ni, Cr, Zr, Ce, Ti, B, and Mn, or coated with an oxide of such hetero elements; LiMO₂ (M is one or more selected from transition metals including Co and Ni); LiₓNi_{α}Co_{β}M_{γ}O₂ (0.9≤x≤1.1, 0.7≤α≤0.9, 0.05≤β≤0.35, 0.01≤γ≤0.1, α+β+γ=1, M is at least one element selected from Mg, Sr, Ti, Zr, V, Nb, Ta, Mo, W, B, Al, Fe, Cr, Mn, and Ce); or LiₓNiₐMn_{b}Co_{c}M_{d}O₂ (0.9≤x≤1.2, 0.3≤a≤0.6, 0.3≤b≤0.4, 0.1≤c≤0.4, 0≤d≤0.4, a+b+c+d=1, M is at least one element selected from Mg, Sr, Ti, Zr, V, Nb, Ta, Mo, W, B, Al, Fe, Cr, and Ce), but is not limited thereto.

The lithium metal oxide of the spinel structure may include LiₐMn₂₋ₓMₓO₄ (M is one or more elements selected from Al, Co, Ni, Cr, Fe, Zn, Mg, B, and Ti, 1≤a≤1.2, 0≤x≤0.2) or Li₄Mn₅O₁₂, but is not limited thereto.

The lithium phosphate-based compound may be a compound capable of reversible insertion and deinsertion of lithium ions and having phosphorus-oxygen bonds. In some embodiments, the lithium phosphate-based compound may be LiₐMₓP_{y}O_{4+z} (0.9≤a≤1.2, 0.99≤x≤1.01, 0.9≤y≤1.2, −0.1≤z≤0.1, and M is at least one metal selected from Fe, Co, Ni, and Mn), but is not limited thereto. An example of part of M in LiₐMₓP_{y}O_{4+z} may be substituted with one or more elements selected from Al, Mg, Ti, Ga, Cu, V, Nb, Zr, Ce, In, Zn, and Y. In addition, together therewith or independently thereof, part of oxygen in LiₐMₓP_{y}O_{4+z} may be substituted with one or more elements selected from nitrogen, sulfur, and fluorine.

In some embodiments, the electrode for a secondary battery may be an anode (negative electrode). When the electrode is a negative electrode, the electrode mixture layer may be a negative electrode mixture layer, and the negative electrode mixture layer may contain a negative electrode active material as an electrode active material.

The negative electrode active material may be a material capable of reversibly intercalating and deintercalating lithium ions, doping or dedoping, or containing metallic lithium. Representative examples of the negative electrode active material may include carbon-based active material, silicon-based active material, metal lithium-based active material, oxide-based active material, or mixtures thereof.

The carbon-based active material may include soft carbon, hard carbon, natural graphite, artificial graphite, carbon nanotubes, graphene, carbon fiber, graphitized mesocarbon microbeads, or a mixture thereof. The representative example of the carbon-based active material includes graphite-based active materials including natural graphite, artificial graphite, and mixtures thereof, but is not limited thereto.

The silicon-based active material may include at least one of Si, SiOₓ (0<x<2), Q-doped or Q-coated SiOₓ (0<x<2), Si-Q alloy, or Si—C composite, wherein Q may be an element selected from the group consisting of alkali metals, alkaline earth metals, Group 13 elements, Group 14 elements, Group 15 elements, Group 16 elements, transition metals, rare earth elements, or a combination of one or more of alkali metals, alkaline earth metals, Group 13 elements, Group 14 elements, Group 15 elements, Group 16 elements, transition metals, and rare earth elements, other than Si.

The metal lithium-based active material may include lithium, a lithium alloy (an alloy of lithium and at least one metal selected from the group consisting of Na, K, Rb, Cs, Fr, Be, Mg, Ca, Sr, Si, Sb, Pb, In, Zn, Ba, Ra, Ge, Al, and Sn), or a mixture thereof.

The oxide-based active material may include an oxide of one or more elements selected from Sn, Ti, Ni, Fe, and Li. Representative examples of the oxide-based active material may include, but are not limited to, Sn oxides, Ti oxides, Ni oxides, Fe oxides (FeO), lithium-titanium oxides (LiTiO₂, Li₄Ti₅O₁₂), their mixtures, or composite oxides thereof.

In some embodiments, the current collector may be a metal commonly used to collect or supply electrons in an electrode of a secondary battery. Specifically, the current collector may include copper, nickel, stainless steel, titanium, or alloys thereof, or a polymer coated with conductive metal, but is not limited thereto. The current collector may have various forms such as foil, perforated foil, foam, fiber-based mesh, etc., but is not limited thereto.

In some embodiments, the electrode may be a negative electrode and the negative electrode mixture layer may contain silicon-based active material. The negative electrode mixture layer containing silicon-based active material may involve large volume change during charge and discharge, thereby causing very high lateral stress. According to some embodiments, the negative electrode, even when the negative electrode mixture layer contains a silicon-based active material that causes significantly high in lateral stress, may not substantially cause problems such as fracture of the current collector during charging/discharging by the negative electrode including a rounded portion satisfying an R/D ratio of 250.0 to 333.3, and durability and life thereof may be significantly improved. Furthermore, even when the current collector of the negative electrode has a thickness of only 1 to 6 μm, that is extremely ultra-thin, and the negative electrode mixture layer contains silicon-based active material, problems such as fracture of the ultra-thin current collector during charging/discharging may not substantially occur due to the rounded portion satisfying R/D of 250.0 to 333.3. In addition, with this ultra-thin current collector and negative electrode containing silicon-based active material, secondary batteries which are lightened, miniaturized, and have high energy density can be implemented.

In some embodiments, the electrode mixture layer (negative electrode mixture layer) may contain a silicon-based active material as an electrode active material (negative electrode active material), and the content of the silicon-based active material in the electrode mixture layer may be 3 to 50 wt %, specifically 3 to 40 wt %, more specifically 3 to 30 wt %, still more specifically 3 to 20 wt %, and even more specifically 3 to 15 wt %. When the content of the silicon-based active material is within the above range, it is possible to prevent detachment of the electrode active material in the electrode mixture layer during charge/discharge while maintaining energy density at an excellent level.

Optionally, when the electrode mixture layer (negative electrode mixture layer) contains a silicon-based active material, the rounded portion 111 having the curvature radius R may satisfy Equation 1 below.

(p×A+q)−r<R≤(p×A+q)+r [Equation 1]

In Equation 1, all parameters p, A, q, r, and R are numerical values without units. The numerical value of R represents a value of the radius of curvature measured in millimeter (mm) of the rounded portion; the value of A corresponds to a weight ratio measured in weight percent (wt %) of the silicon-based active material to the electrode mixture layer; p is a numerical value ranging from 0.05 to 0.2; q is a numerical value ranging from 0.1 to 1; and r is a numerical value ranging from 0.1 to 1. As an example, when a weight ratio of the silicon-based active material to the electrode mixture layer 20 is 10 wt % (In other words, A is 10), p is 0.1, q is 0.5, and r is 0.5, the value of the radius R of curvature of the rounded portion 111 may be greater than 1.0 mm, may be equal to or greater than 1.5 mm, and may be less than or equal to 2.0 mm.

In some embodiments, when the electrode active material contained in the electrode mixture layer contains a silicon-based active material, the electrode active material may further contain a carbon-based active material together with the silicon-based active material. When the carbon-based active material is further included, the content of the carbon-based active material may be 40 to 95 wt %, specifically 40 to 90 wt %. The content of the carbon-based active material may be based on the total weight of the electrode mixture layer.

In some embodiments, the electrode mixture layer may further include a conductive material, a binder, or both of the conductive material and a binder in addition to an electrode active material.

The conductive material is not limited as long as it is a known conductive material used to improve the electric conductivity of an electrode mixture layer in a secondary battery electrode. For example, the conductive material may be one or more selected from carbon-based conductive materials, metals, conductive metal oxides, conductive organic compounds and conductive metal compounds. An example of the carbon-based conductive material may include artificial graphite, natural graphite, exfoliated graphite, carbon nanotubes, conductive carbon fibers, graphene, acetylene black, Ketjen black, channel black, Denka black, lamp black, furnace black, thermal black, or mixtures thereof. An example of the metal may include copper, copper alloys, nickel, nickel alloys, aluminum, aluminum alloys, silver, silver alloys, tin, tin alloys, mixtures thereof, or alloys thereof, and may have particle shapes, plate shapes, or fiber shapes. An example of the conductive metal oxide may include titanium oxide, tin oxide, ruthenium oxide, transparent conductive oxides (ITO, FTO, AZO, GZO, etc.), perovskite-structured conductive metal oxides (LaSrCoO₃, LaSrMnO₃, etc.) or mixtures thereof. An example of the conductive organic materials may be conductive polymers, which may include polyaniline, polythiophene, poly(3-hexylthiophene), polyacetylene, polypyrrole, polyfluorene, polyacetylene, or mixtures thereof. When the electrode mixture layer further contains a conductive material, the content of the conductive material in the electrode mixture layer may be 0.1 to 10 wt %, but is not limited thereto. At this time, the content of the conductive material may be based on the total weight of the electrode mixture layer.

The binder is not particularly limited as long as it is an organic material known to be used for binding between the electrode mixture layer and the current collector in a secondary battery electrode and binding between components of the mixture layer (active material, conductive material, etc.) in the electrode mixture layer. For example, the binder may include styrene-butadiene rubber, polytetrafluoroethylene, polyvinylidene fluoride, vinylidene fluoride/hexafluoropropylene copolymer, polyacrylonitrile, polymethylmethacrylate, or mixtures thereof, but is not limited thereto. As an another example, the binder may be at least one rubber-based binder selected from the group consisting of styrene-butadiene rubber (SBR), fluorine-based rubber, ethylene propylene rubber, butyl acrylate rubber, butadiene rubber, isoprene rubber, acrylonitrile rubber, acrylic rubber and silane-based rubber; a cellulosic binder, such as carboxymethylcellulose (CMC), hydroxypropylmethylcellulose, methylcellulose, or alkali metal salt thereof; a water-soluble polymer-based binder, such as a polyacrylic acid (PAA)-based binder, a polyvinyl alcohol (PVA)-based binder, and a polyvinyl alcohol-polyacrylic acid (PVA-PAA) copolymer-based binder; and combinations thereof. When the electrode mixture layer further includes a binder, a weight ratio of the binder may be 0.1 to 10 wt %. The weight ratio of the binder may be a value calculated based on a total weight of the electrode mixture layer.

In some embodiments, the change rate in the direction of the electrode surface (electrode surface direction) may be 0.1 to 2.5%, specifically 0.1 to 2.0%. The change rate in the direction of the electrode surface may be a change rate of the length of the electrode mixture layer along the first or second direction at the fully charged state (e.g., SOC 100%) or the fully discharged state (e.g., SOC 0%). An example of the change rate may be |t2−t1|/t1×100(%) when the length of the electrode mixture layer in the first or second direction is t1 in the fully discharged state and the length of the electrode mixture layer in the same direction is t2 in the fully charged state. At this time, when the change rate in the first direction (first change rate) and the change rate in the second direction (second change rate) are different from each other, the change rate in the direction of the electrode surface may mean a larger value among two change rates (the first change rate and the second change rate).

In some embodiments, the electrode may be prepared by applying an electrode slurry containing an electrode active material to a current collector and then drying and rolling it. If necessary, the electrode slurry may further contain a conductive material, a binder or both a conductive material and a binder in addition to the electrode active material. The solvent of the slurry may include water, pure water, deionized water, distilled water, ethanol, isopropanol, methanol, acetone, n-propanol, t-butanol, N-methyl-2-pyrrolidone (NMP), dimethylformamide, dimethylacetamide, N,N-dimethylaminopropylamine, ethylene oxide, tetrahydrofuran, etc., but is not limited thereto. Application may be performed using methods such as gravure coating, slot die coating, multilayer simultaneous die coating, imprinting, doctor blade coating, dip coating, bar coating, casting, etc., but is not limited thereto. The slurry may be applied to a region previously defined as the body portion in the current collector.

The current collector used in the manufacture of an electrode may include a body portion on which the positive electrode mixture layer is located (to which the electrode slurry is applied) and a bare portion, wherein the bare portion may include an electrode tab portion. In addition, the current collector may include the aforementioned rounded portion disposed on the side of the body portion of the electrode tab portion. The electrode tab portion and the rounded portion may be formed by cutting off a part of the current collector using a method such as laser notching before or after application of the electrode slurry.

### Method for Designing Electrode

The method of designing an electrode for a secondary battery according to one embodiment includes the operations of: setting, in a current collector including a body portion on which an electrode mixture layer is located and an electrode tab portion extending from the body portion, with a direction in which the electrode tab portion extends defined as a first direction in a region including an intersection point where a third straight edge portion in a second direction perpendicular to the first direction on one side of the current collector on which the electrode tab portion is located and a fourth straight edge portion in the first direction of the electrode tab portion intersect with each other as a rounded portion region connecting the third straight edge portion and the fourth straight edge portion (region setting operation); and setting a curvature radius of the rounded portion based on a thickness of the current collector (curvature setting operation).

The electrode for a secondary battery designed by the design method may include a current collector and an electrode mixture layer disposed on at least one surface of the current collector. The specific materials and compositions of the electrode mixture layer may be similar to or identical with those described above in connection with the electrodes for secondary batteries.

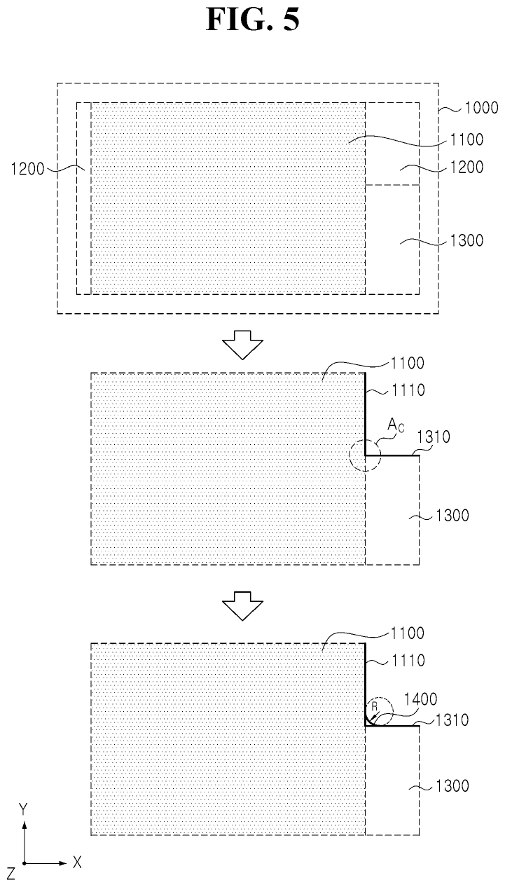

FIG. 5 is a schematic view showing the design operations according to the design method in one embodiment. As shown in an example of FIG. 5, the design method according to one embodiment may further include, before the region setting operation, an operation of dividing (dividing operation) with respect to at least one surface of the current collector 1000, a body portion 1100 on which the electrode mixture layer is to be located, a bare portion 1200 on which the electrode mixture layer is not to be located, and an electrode tab portion 1300 to be formed by cutting a part of the bare portion 1200. In the dividing operation, the current collector 1000 on which the body portion 1100, the bare portion 1200, and the electrode tab portion 1300 belonging to the bare portion are divided may have a shape of a membrane (a film) extending in two directions orthogonal to each other and having a thickness D. The film-shaped current collector divided in the dividing operation may be a simple film type. The current collector on which mechanical processing such as cutting has been performed so as to conform to the design made in the dividing operation, the region setting operation, and the curvature setting operation (processed current collector) may correspond to the current collector of the above-described electrode for a secondary battery. However, as shown in an example of FIG. 5, in the region setting operation and the curvature setting operation, not a film shape but a current collector already processed according to what has been divided in the dividing operation may be assumed, and the region setting operation and the curvature setting operation may be performed.

In the region setting operation, an region including a crossing point at which the third straight edge portion 1110 in the second direction and the fourth straight edge portion 1310 of the electrode tab portion 1300 in the first direction cross each other may be set as the rounded portion region A_{C} connecting the third straight edge portion 1110 and the fourth straight edge portion 1310. The rounded portion may be located on the rounded portion region Ac. The rounded portion may be a curved edge portion connecting the third straight edge portion 1110 and the fourth straight edge portion 1310.

After the rounded portion region A_{C} is set, a curvature setting operation of setting a curvature radius R of a curved edge portion connecting the third straight edge portion 1110 and the fourth straight edge portion 1310 may be performed. In the curvature setting operation, an R value may be set such that a ratio R/D of the curvature radius R to the thickness D of the current collector satisfies 250.0 to 333.3. At this time, the thickness of the current collector may be in a range of 1.0 to 10.0 μm. Specifically, the current collector may be an ultra-thin current collector having a thickness D less than 8.0 μm. The thickness D of the ultra-thin current collector may be 1.0 μm or more and less than 8.0 μm, specifically, 1.0 to 7.5 μm, 1.0 to 7.0 μm, 1.0 to 6.5 μm, 1.0 to 6.0 μm, 3.0 to 7.0 μm, 3.0 to 6.5 μm, or 3.0 to 6.0 μm. In the curvature setting operation, after the curvature radius R of the rounded portion 1400 is set, the rounded portion 1400 may be disposed so as to position an arc with the corresponding curvature in the rounded portion region A_{C} and connect the third straight edge portion 1110 and the fourth straight edge portion 1310 without interruption, and the length (arc length) may be set.

As such, the current collector and electrode having an outer periphery conforming to the rounded portion defined by the dividing operation, the region setting operation, and the curvature setting operation may be designed.

In addition, the design method according to one embodiment may further include a mixture layer designing operation of setting the types of electrode active material and contents thereof for each type of electrode active material in the electrode mixture layer such that a change rate in the direction of the surface (electrode surface) of the electrode satisfies 0.1% to 2.5%, specifically, 0.1% to 2.0%. The mixture layer designing operation may be performed before the dividing operation or after the curvature setting operation. At this time, the change rate is the same as described above in connection with the electrodes for secondary batteries.

According to the design method of one embodiment, an electrode may be manufactured by applying an electrode slurry to a current collector in the form of a membrane or film so as to conform to the body portion designed according to the design method, forming an electrode mixture layer by drying and rolling, and then performing mechanical processing such as cutting so as to have a bare portion, an electrode tab portion, and a rounded portion designed according to the design method.

### Lithium Secondary Battery

The lithium secondary battery according to one embodiment includes the above-described electrode. Specifically, in some embodiments, the lithium secondary battery may include an electrode containing a positive electrode active material as a positive electrode. In other embodiments, the lithium secondary battery may include an electrode containing a negative electrode active material as a negative electrode. In still other embodiments, the lithium secondary battery may include an electrode containing a positive electrode active material as a positive electrode and an electrode containing a negative electrode active material as a negative electrode. In the secondary battery, a separator may be interposed between the positive electrode and the negative electrode. In addition, the secondary battery may also include an electrolyte together with the positive electrode, the negative electrode, and the separator interposed between the positive electrode and the negative electrode. In the secondary battery, the positive electrode active material or composition of the positive electrode mixture layer, the negative electrode active material or composition of the negative electrode mixture layer, the separator, the salt of the electrolyte, the solvent of the electrolyte, or the concentration of the electrolyte may be materials or compositions commonly adopted in lithium secondary batteries.

The separator can be implemented in various ways suitable for a lithium secondary battery. As an example, the separator may include a porous substrate, and the porous substrate may be a polyolefin-based porous substrate. The polyolefin-based porous substrate may be a substrate having a plurality of pores and commonly used in electrochemical devices. The polyolefin-based porous substrate may be selected from the group consisting of a polyethylene single film, a polypropylene single film, a polyethylene/polypropylene double film, a polypropylene/polyethylene/polypropylene triple film, and a polyethylene/polypropylene/polyethylene triple film, but is not limited thereto. In an embodiment, the thickness of the separator may be 10 μm to 20 μm, but is not limited thereto.

The electrolyte may include a liquid electrolyte and the liquid electrolyte may include a non-aqueous electrolytic solution. The non-aqueous electrolytic solution may include a lithium salt as an electrolyte salt and an organic solvent. An anion (X⁻) of the lithium salt represented by Li⁺X⁻ may be selected from one or more of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻ and (CF₃CF₂SO₂)₂N⁻, but is not limited thereto.

An example of the nonaqueous electrolyte may include a carbonate-based solvent, an ester-based solvent, an ether-based solvent, a ketone-based solvent, an alcohol-based solvent or a mixture thereof as an organic solvent, but is not limited thereto. Specifically, the carbonate-based solvent may include cyclic carbonates, linear carbonates or mixtures thereof. Representative examples of the cyclic carbonate-based solvent may include ethylene carbonate (EC), propylene carbonate (PC), butylene carbonate (BC) and mixtures thereof. The linear carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC) and mixtures thereof. The ester-based solvent may include gamma-butyrolactone (GBL), methyl acetate, ethyl acetate, propyl acetate, butyl acetate, methyl propionate, ethyl propionate and mixtures thereof. The ether-based solvent may include 1,2-dimethoxyethane, 1,3-dioxolane, diethyl ether, dibutyl ether, triethylene glycol dimethyl ether, diethylene glycol dimethyl ether, tetrahydrofuran, oxane and mixtures thereof. The ketone-based solvent may include acetone, methyl ethyl ketone, methyl isobutyl ketone, or a mixture thereof. The alcohol-based solvent may include ethanol, isopropyl alcohol and mixtures thereof. If necessary, the nonaqueous electrolyte may further include an aromatic hydrocarbon-based solvent. The aromatic hydrocarbon-based solvent may include benzene, fluorobenzene, bromobenzene, chlorobenzene, cyclohexylbenzene, isopropylbenzene, n-butylbenzene, octylbenzene, toluene, xylene, mesitylene and mixtures thereof. However, the solvents of the nonaqueous electrolyte are not limited to the above-described specific organic solvents.

If necessary, the nonaqueous electrolytic solution may further include additives, and representative additives added to the electrolytic solution of a lithium secondary battery may include cyclic carbonate-based compounds (e.g., vinylene carbonate, vinyl ethylene carbonate, etc.), fluorine-substituted carbonate-based compounds (e.g., fluoroethylene carbonate, etc.), sultone-based compounds (e.g., 1,3-propane sultone, 1,3-propene sultone, 1,4-butane sultone, etc.), cyclic sulfate-based compounds (e.g., 1,2-ethylene sulfate, 1,2-propylene sulfate, etc.), cyclic sulfite-based compounds (e.g., ethylene sulfite, butylene sulfite, etc.), phosphate-based compounds (e.g., lithium difluoro bis(oxalato) phosphate, lithium difluoro phosphate, etc.), borate-based compounds (e.g., lithium bis(oxalato) borate, etc.), or a mixture thereof, but is not limited thereto.

The concentration of the electrolyte salt in the non-aqueous electrolytic solution may be at a level of 0.5 to 2.0 M, but is not limited thereto.

By incorporating the aforementioned electrodes as the positive electrode, negative electrode, or both the positive electrode and negative electrode, a lithium secondary battery can be provided that offers improved energy density, capacity characteristics, and cycle life, while also being producible at a lower cost.

### EXAMPLE

### 1. Design of Electrode for Secondary Battery

### (1) Comparative Example and Reference Example

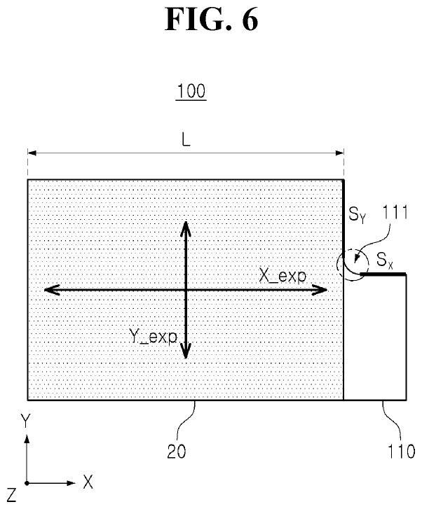

An Electrode of Comparative Example 1 including an current collector (Cu-foil) including a body portion (also referred to as a coated portion) in which an electrode mixture layer including 10 wt % of silicon-based active material (SiOₓ; 0<x<2) based on a solid content is formed on one surface; and an bare portion (also referred to as a uncoated portion) excluding the coated portion was modeled (refer to FIG. 6). At this time, a thickness D of the current collector of Comparative Example 1 was 6 μm, the current collector included a rounded portion having a value of radius R of curvature of 1.0 mm, and the coated portion was modeled such that only 95 mm, which is a portion of the total length of 262 mm, was a length L of the coated portion. In addition, electrodes of Comparative Example 2 to Comparative Example 4 were modeled by designing the same as that of the electrode of Comparative Example 1, except that the radius R of curvature of the rounded portion was set to 1.4 mm and the thickness D of the current collector was set to 6 μm for Comparative Example 2, the radius R of curvature of the rounded portion to 1.2 mm and the thickness D of the current collector to 5 μm for Comparative Example 3, and the radius R of curvature of the rounded portion to 2.1 mm and the thickness D of the current collector to 6 μm for Comparative Example 4.

In addition, an electrode of Reference Example was modeled by designing the same as that of the electrode of Comparative Example 1, but the thickness D of the current collector was set to 8 μm.

### (2) Examples 1 to 4

Electrodes of Examples 1 to 4 were modeled by designing the same as that of the electrode of Comparative Example 1, except that the radius R of curvature of the rounded portion was set to 1.5 mm and the thickness D of the current collector was set to 6 μm for Example 1, the radius R of curvature of the rounded portion to 2.0 mm and the thickness D of the current collector to 6 μm for Example 2, the radius R of curvature of the rounded portion to 1.7 mm and the thickness D of the current collector to 6 μm for Example 3, and the radius R of curvature of the rounded portion to 1.5 mm and the thickness D of the current collector to 5 μm for Example 4.

### (3) Symmetry Condition for Each Direction and PS Value for Each Expansion Rate

Each of the modeled electrodes was set to have a symmetry condition in the horizontal and vertical directions (the X-axis and the Y-axis) (refer to FIG. 6). At this time, considering that each electrode is stacked in an actual secondary battery, a thickness direction (a Z-axis) is also set to have a symmetry condition.

In addition, considering the expansion of the electrode mixture layer including the silicon-based active material during the battery charging/discharging process, the expansion rate value was input so that the electrode mixture layer in each modeled electrode expands by 1% in the horizontal and vertical directions (the X-axis and the Y-axis), respectively, and the expansion rate value was input so that the electrode mixture layer in each modeled electrode expands by 1.5% in the horizontal and vertical directions (the X-axis and the Y-axis) under the same condition, respectively, and PS values according to each expansion rate are shown in Table 1 below. The PS value indicates the maximum plastic strain value of the rounded portion. Plastic strain is a numerical value indicating, in percentage (%), the degree of deformation of a material when plastic deformation occurs, in which permanent deformation occurs without returning to the original shape even when an external force is removed from the material to which the external force has been applied. A plastic strain value of the rounded portion may be a plastic strain value in a curved portion between a first point X, which is present between the second straight edge portion and the rounded portion and is a point at which the shape changes from a straight shape to a curved shape; and a second point Y, which is present between the first straight edge portion and the rounded portion and is a point at which the shape changes from a straight shape to a curved shape. The plastic strain value of the rounded portion may be measured and calculated by fixing the electrode to a tensile strength measuring device and pulling the bare portion.

At this time, the PS value when the expansion rate value was input so that the electrode mixture layer expands by 1.3% in the horizontal and vertical directions (the X-axis and the Y-axis), respectively, under the same condition is also shown in Table 1 below.

### 2. Evaluation of Electrode for Secondary Battery

### (1) Manufacturing of Electrode

Designed electrodes of Example, Comparative Example and Reference Example were actually manufactured to evaluate whether fracture actually occurs in the current collector and the expansion rate during the charging/discharging process. At this time, in each of the manufactured electrodes (anodes), a weight ratio of carbon-based active material (artificial graphite) to the electrode mixture layer was 87 wt % based on a solid content, a weight ratio of silicon-based active material was 10 wt %, and a weight ratio of binders (SBR and CMC) was 1.5 wt %, and a weight ratio of the conductive material (CNT) was 1.5 wt %.

Thereafter, the secondary battery cell prepared by interposing a polyolefin separator between a cathode in which a cathode mixture layer including the NCM-based cathode active material was formed on a cathode current collector (Al-foil) and the electrode (anode) prepared above was placed in a secondary battery pouch, and thereafter, an electrolyte solution in which 1M LiPF₆ was dissolved in a mixed solvent of ethylene carbonate (EC) and diethyl carbonate (DEC) was injected into the secondary battery pouch, and then sealed to manufacture a pouch-type lithium secondary battery.

### (2) Fracture Occurrence and Expansion Rate

After repeating the cycle of charging at ⅓C and discharging at ⅓C at 25 °C in the range of 0 to 100% of SOC with respect to the manufactured secondary battery one or more times, whether fracture occurs in an edge portion of the current collector was visually evaluated. A case in which fracture occurred was marked as ∘ and a case in which fracture did not occur was marked as X and results thereof are shown in Table 1 below.

In addition, after repeating the cycle of charging at ⅓C and discharging at ⅓C at 25 °C in the range of 0 to 100% of SOC with respect to the manufactured secondary battery one or more times, according to a measurement of an expansion rate in the direction of the electrode surface according to the equation: Expansion rate (%)=(T₂−T₁)/T₁×100, wherein the T₁ is a length of the electrode in the surface direction in a discharged state (SOC 0%) before charging and the T₂ is a length of the electrode in the surface direction in a charged state (SOC 100%), the expansion rates of the major axis (the X-axis) and minor axis (the Y-axis) in the surface direction were 1%, respectively.

In some implementations, a plastic strain value of the rounded portion and a PS value corresponding thereto may be measured and calculated by pulling the bare portion by a tensile strength measurement device after the electrode (anode) is fixed, regarding the curved portion between the first point X and the second point Y.

TABLE 1

| | Comparative | Reference | | | | | Comparative | Comparative | Comparative |
|---|---|---|---|---|---|---|---|---|---|
| | Example 1 | Example | Example 1 | Example 2 | Example 3 | Example 4 | Example 2 | Example 3 | Example 4 |
| Radius of | 1.0 | 1.0 | 1.5 | 2.0 | 1.7 | 1.5 | 1.4 | 1.2 | 2.1 |
| curvature | | | | | | | | | |
| (R)[mm] | | | | | | | | | |
| Thickness | 6 | 8 | 6 | 6 | 6 | 5 | 6 | 5 | 6 |
| of | | | | | | | | | |
| electrode | | | | | | | | | |
| (D) [um] | | | | | | | | | |
| R/D [um/ | 166.7 | 125.0 | 250.0 | 333.3 | 283.3 | 300.0 | 233.3 | 240.0 | 350.0 |
| um] | | | | | | | | | |
| Length of | 95 | 95 | 95 | 95 | 95 | 95 | 95 | 95 | 95 |
| coated | | | | | | | | | |
| portion(L) | | | | | | | | | |
| [mm] | | | | | | | | | |
| PS value | 12.87 | 12.35 | 8.86 | 5.44 | 7.54 | 8.21 | 11.86 | 13.28 | 13.27 |
| (when | | | | | | | | | |
| expended | | | | | | | | | |
| by 1%)[%] | | | | | | | | | |
| PS value | 28.35 | 26.41 | 15.73 | 9.39 | 14.21 | 10.38 | 20.65 | 24.86 | 26.87 |
| (when | | | | | | | | | |
| expended | | | | | | | | | |
| by | | | | | | | | | |
| 1.5%)[%] | | | | | | | | | |
| Occurrence | ◯ | X | X | X | X | X | ◯ | ◯ | ◯ |
| of fracture | | | | | | | | | |
| Actual | 1 | 1 | — | — | — | — | — | — | — |
| expansion | | | | | | | | | |
| rate [%] | | | | | | | | | |

Referring to Table 1, it can be seen that, in the case of the electrode of Reference Example in which the thickness D of the current collector was designed to be relatively large compared to Comparative Example 1, the maximum plastic strain value of the rounded portion was relatively low even if the same expansion rate was input. In addition, the electrodes of Comparative Example 1 and Reference Example were actually manufactured and whether fracture occurred during the charging/discharging process under the same condition was evaluated and results thereof show that fracture did not occur in the electrode of Reference Example, unlike the electrode of Comparative Example 1 in which fracture occurred although the actual expansion rate was the same. Considering this, if the thickness of the anode current collector is designed to be relatively large when the value of the radius of curvature of the rounded portion is the same, it is determined that the plastic strain of the rounded portion may be reduced during charging/discharging to suppress fracture of the anode current collector.

Meanwhile, at the same expansion rate, it can be seen that in Examples 1 and 2 where the maximum plastic strain value of the rounded portion is controlled to be lower than those of Comparative Example 1 and Reference Example by means of the R/D value, stress due to electrode expansion is greatly alleviated and fracture of a current collector is effectively inhibited. In addition, even when the expansion rate of the electrode increased, the maximum plastic strain value of the negative electrodes of Examples 1 to 4 was maintained significantly lower than that of the negative electrodes of the Reference Example and Comparative Examples. Considering this, it can be seen that even if an expansion rate having the same or higher value as the conventional electrode surface direction expansion rate is applied during charge/discharge of an electrode manufactured according to the design of Examples 1 to 4, fracture of a current collector may be effectively prevented. As in Examples 1 to 4, an electrode including a rounded portion having a curvature radius R value such that R/D satisfies 250.0 to 333.3 can substantially prevent occurrence of fracture of the current collector during a charging/discharging process while maintaining a small thickness of the current collector, even when the electrode has a large surface direction expansion rate by containing a silicon-based active material and the like, thereby enabling implementation of a secondary battery having excellent energy density, economic efficiency, life characteristics, etc.

Only specific examples of implementations of certain embodiments are described. Variations, improvements and enhancements of the disclosed embodiments and other embodiments may be made based on the disclosure of this patent document.

What is claimed is:

1. An electrode for a secondary battery comprising:
a current collector comprising a body portion and an electrode tab portion extending from the body portion;
and an electrode mixture layer located on the body portion,
wherein, with a direction in which the electrode tab portion extends defined as a first direction, the current collector comprises a first straight edge portion in a second direction, perpendicular to a first direction on one side of the current collector on which the electrode tab portion is located,
the first straight edge portion and a second straight edge portion in the first direction of the electrode tab portion are connected by a rounded portion, which is a curved edge portion, and
a ratio R/D of a curvature radius R of the rounded portion to a thickness D of the current collector is 250.0 to 333.3.

2. The electrode for a secondary battery of claim 1, wherein the rounded portion is comprised in a circumference of the body portion on the current collector.

3. The electrode for a secondary battery of claim 1, wherein the rounded portion is comprised in a circumference of a bare portion comprising the electrode tab portion on the current collector.

4. The electrode for a secondary battery of claim 1, wherein the thickness D of the current collector is in a range of 1.0 to 10.0 μm.

5. The electrode for a secondary battery of claim 1, wherein the rounded portion is located at both ends of the body portion side of the electrode tab portion.

6. The electrode for a secondary battery of claim 1, wherein the electrode is a positive electrode or a negative electrode.

7. The electrode for a secondary battery of claim 1, wherein the electrode mixture layer comprises a silicon-based active material.

8. The Electrode of claim 7, wherein the silicon-based active material comprises at least one of Si, SiOₓ (0<x<2), Q-doped or Q-coated SiOₓ (0<x<2), Si-Q alloy, or Si—C composite,
wherein Q is an element selected from the group consisting of alkali metals, alkaline earth metals, Group 13 elements, Group 14 elements, Group 15 elements, Group 16 elements, transition metals, rare earth elements, or a combination of one or more of alkali metals, alkaline earth metals, Group 13 elements, Group 14 elements, Group 15 elements, Group 16 elements, transition metals, and rare earth elements, other than Si.

9. The electrode for a secondary battery of claim 1, wherein the electrode mixture layer comprises a carbon-based active material.

10. The electrode for a secondary battery of claim 9, wherein the carbon-based active material comprises soft carbon, hard carbon, natural graphite, artificial graphite, carbon nanotubes, graphene, carbon fiber, graphitized mesocarbon microbeads, or mixtures thereof.

11. The electrode for a secondary battery of claim 7, wherein the content of the silicon-based active material in the electrode mixture layer is 3 to 50 wt %.

12. The electrode for a secondary battery of claim 1, wherein the electrode mixture layer further comprises a conductive material, a binder, or both of the conductive material and a binder.

13. A lithium secondary battery comprising the electrode for a secondary battery according to claim 1.

14. A method of designing an electrode for a secondary battery, comprising the operations of:
in a current collector comprising a body portion on which an electrode mixture layer is located and an electrode tab portion extending from the body portion,
setting, with a direction in which the electrode tab portion extends defined as a first direction, a region comprising an intersection point where a third straight edge portion in a second direction perpendicular to the first direction on one side of the current collector on which the electrode tab portion is located and a fourth straight edge portion in the first direction of the electrode tab portion intersect with each other as a rounded portion region connecting the third straight edge portion and the fourth straight edge portion; and
setting a curvature radius of the rounded portion based on a thickness of the current collector.

15. The method of designing an electrode for a secondary battery of claim 14, wherein the curvature R of the rounded portion is set such that a ratio R/D of the curvature radius R to the thickness D of the current collector satisfies 250.0 to 333.3.
